(19) United States
(12) Patent Application Publication
(10) Pub. No.: US 2026/0245773 A1
(43) Pub. Date: Aug. 20, 2026

(54) WIRE AUTOMATION SYSTEMS, JIG BOARDS FOR WIRE AUTOMATION SYSTEMS, AND METHODS FOR ASSEMBLING ELECTRICAL RACEWAYS

(71) Applicant: The Boeing Company, Arlington, VA (US)

(72) Inventors: Shawn D. Mohlman, Mill Creek, WA (US); Ryan P. Rogers, Woodinville, WA (US); Lars E. Blacken, Bothell, WA (US); Aldo M. Barletta, Lake Stevens, WA (US); Jeffrey A. McCaskey, Everett, WA (US); Karen T. Biemann, Everett, WA (US); Thi Q. Nguyen, Everett, WA (US); Bradley J. Mitchell, Snohomish, WA (US)

(73) Assignee: The Boeing Company, Arlington, VA (US)

(21) Appl. No.: 19/055,650

(22) Filed: Feb. 18, 2025

(51) Int. Cl. H01B 13/012

(52) U.S. Cl. CPC H01B 13/01245; H01B 13/01209

(57) ABSTRACT

A wire automation system includes a jig board, a pre-processing cell, a wire automation cell, a post-processing cell, and a transportation platform. The jig board is configured for routing of wires of a wire raceway along a linear path and a non-linear path. The pre-processing cell is configured for placement of wire raceway hardware and wire routing hardware on the jig board. The wire automation cell is configured for automated placement of the wires on the jig board. The wire automation cell is linked in series with the pre-processing cell. The post-processing cell is configured for removal of the wire raceway from the jig board. The post-processing cell is linked in series with the wire automation cell. The transportation platform is configured for moving the jig board sequentially through the pre-processing cell, the wire automation cell, and the post-processing cell.

### FIELD

The present disclosure relates generally to electrical raceway systems and, more particularly, to automated wire routing systems, jig boards for wire routing, and methods for assembling electrical raceways.

### BACKGROUND

Many vehicles, such as aircraft, have complex electrical system distributed through the body of the vehicle. Such electrical systems require bundles of wires, cables, conduits, connectors, and related fittings, referred to as an electrical wire raceway, to connect the various electrical components. During assembly of the electrical wire raceway, groups of wires need to be routed and held in position for bundling. For products having a large quantity of wire bundles, wire processing represents a significant portion of the overall production. Manual wire routing and bundling processes enable varying wire routing configurations but are time and labor intensive. Automated routing and bundling processes reduce the time required for forming wire bundles but provide limited wire routing variations. Accordingly, those skilled in the art continue with research and development efforts in the field of electrical wire raceway production.

### SUMMARY

Disclosed are examples of a wire automation system, a jig board, and a method for assembling a wire raceway. The following is a non-exhaustive list of examples, which may or may not be claimed, of the subject matter according to the present disclosure.

In an example, the disclosed system includes a jig board, a pre-processing cell, a wire automation cell, a post-processing cell, and a transportation platform. The jig board is configured for assembling a wire raceway by routing of wires along a linear path and a non-linear path. The pre-processing cell is configured for placement of wire raceway hardware and wire routing hardware on the jig board. The wire automation cell is configured for automated placement of the wires on the jig board. The wire automation cell is linked in series with the pre-processing cell. The post-processing cell is configured for removal of the wire raceway from the jig board. The post-processing cell is linked in series with the wire automation cell. The transportation platform is configured to move the jig board sequentially through the pre-processing cell, the wire automation cell, and the post-processing cell.

In an example, the disclosed jig board includes a board assembly configured for routing of wires along a linear path and a non-linear path. The jig board also includes wire routing hardware coupled to the board assembly.

In an example, the disclosed method includes steps of: (1) positioning a jig board in a pre-processing cell; (2) coupling wire raceway hardware and wire routing hardware to the jig board along a linear path; (3) moving the jig board from the pre-processing cell to a wire automation cell; (4) automatically routing wires along the linear path on the jig board to form a wire bundle coupled to the wire raceway hardware and the wire routing hardware using a plurality of robotic manipulators; (5) moving the jig board from the wire automation cell to a post-processing cell; and (6) rerouting a wire bundle section of the wire bundle from the linear path to a non-linear path using the jig board.

Other examples of the system, the jig board, and the method will become apparent from the following detailed description, the accompanying drawings, and the appended claims.

### BRIEF DESCRIPTION OF THE DRAWINGS

FIG. 1 is a schematic block diagram of an example of a system for automated assembly of electrical raceways;

FIG. 2 is a flow diagram of an example of a method for assembling electrical raceways;

FIG. 3 is a schematic illustration of an example of the system;

FIG. 4 is a schematic illustration of an example of a pre-processing cell of the system;

FIG. 5 is a schematic illustration of an example of a jig board in the pre-processing cell;

FIG. 6 is a schematic illustration of an example of the jig board transitioning from the pre-processing cell to an automated wire assembly cell of the system;

FIG. 7 is a schematic illustration of an example of the automated wire assembly cell;

FIG. 8 is a schematic illustration of an example of post-processing cell wire cell of the system;

FIG. 9 is a schematic illustration of an example of the jig board transitioning from the automated wire assembly cell to the post-processing cell;

FIG. 10 is a schematic illustration of an example of the jig board in the post-processing cell;

FIGS. 11A-11D, collectively FIG. 11, are schematic illustrations of an example of a transportation tool of the system;

FIGS. 12A and 12B, collectively FIG. 12, are schematic illustrations of an example of the jig board;

FIGS. 13A and 13B, collectively FIG. 13, are schematic illustrations of an example of the jig board;

FIGS. 14A-14C, collectively FIG. 14, are schematic illustrations of an example of the jig board;

FIG. 15 is a schematic illustration of an example of an aircraft; and

FIG. 16 is a flow diagram of an example of an aircraft manufacturing and service method.

### DETAILED DESCRIPTION

Generally, the following detailed description describes systems, methods, and associated tooling components for automated production of electrical wire raceways and electrical wire harnesses. The systems, methods, and components described herein enable integration of manual and automated tasks, which advantageously provide increases in production efficiency, decreases in fabrication time, and assembly flexibility not otherwise available. The systems, methods, and components also advantageously facilitate adjustments to the routing paths of wire bundles that form the electrical wire raceways.

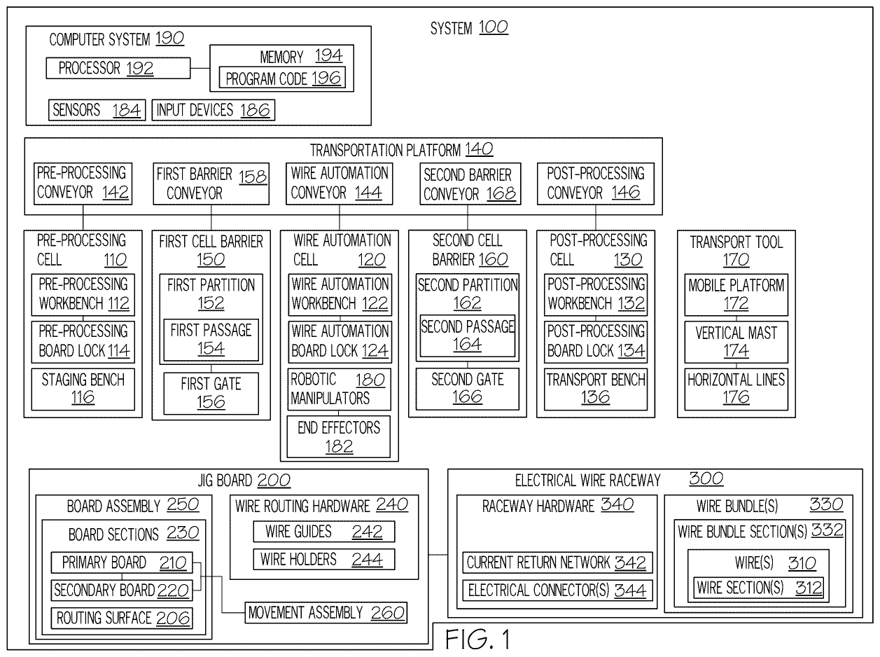

Referring now to FIGS. 1 and 3-14 by way of examples, the present disclosure is directed to a system 100 for automated production of wire raceways, wire harnesses, wire bundles, and the like, which is also referred to herein as a wire automation system. The following are examples of the system 100, according to the present disclosure. Examples of the system 100 include a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

FIG. 1 depicts one or more examples of the system 100. As will be described in more detail herein, in one or more examples, the system 100 includes a number of elements, features, and/or components, including one or more, or combinations, of a jig board 200, a board assembly 250, a primary board 210, a secondary board 220, wire routing hardware 240, wire raceway hardware 340, a pre-processing cell 110, a wire automation cell 120, a post-processing cell 130, a transportation platform 140, a computer system 190, a pre-processing workbench 112, a pre-processing board lock 114, a wire automation workbench 122, a wire automation board lock 124, a post-processing workbench 132, a post-processing board lock 134, a first cell barrier 150, a second cell barrier 160, a pre-processing conveyor 142, a wire automation conveyor 144, a post-processing conveyor 146, a first partition 152, a first passage 154, a first gate 156, a second partition 162, a second passage 164, a second gate 166, a first barrier conveyor 158, a second barrier conveyor 168, a transport tool 170, a staging bench 116, a transport bench 136, a plurality of robotic manipulators 180, end effectors 182, sensors 184, and input devices 186.

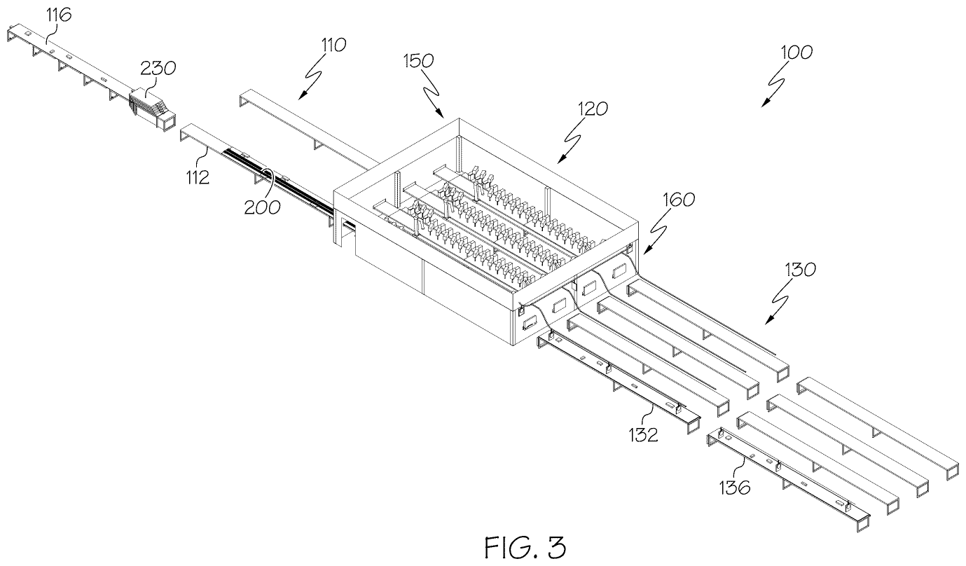

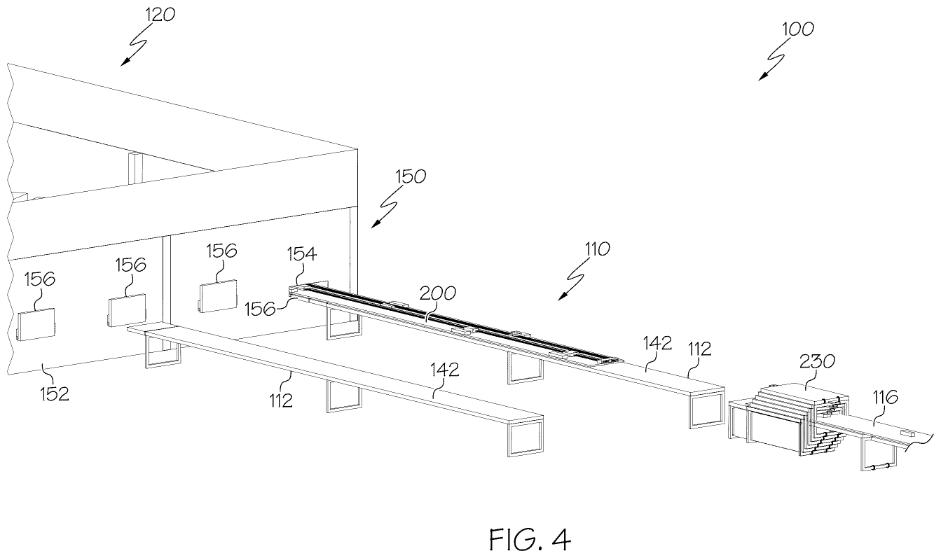

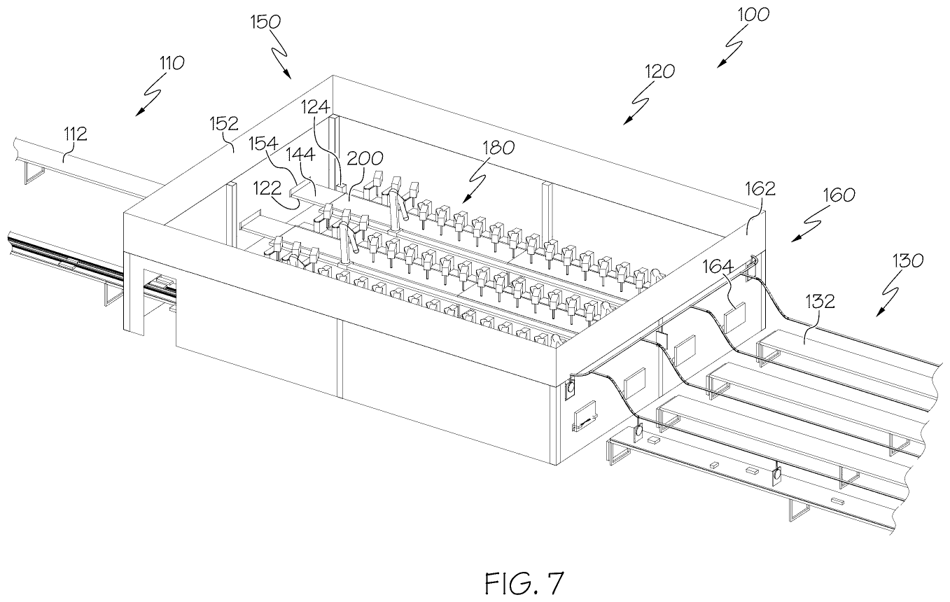

FIG. 3 depicts an example of a manufacturing environment in which the system 100 operates. In one or more examples, the system 100 includes the pre-processing cell 110, the wire automation cell 120, and the post-processing cell 130. Generally, the pre-processing cell 110, the wire automation cell 120, and the post-processing cell 130 are linked or otherwise associated with each other in the manufacturing environment or form sequential stages of a manufacturing operation, as illustrated in FIG. 3. As an example, the wire automation cell 120 is linked in series with the pre-processing cell 110. The post-processing cell 130 is linked in series with the wire automation cell 120. FIGS. 4-6 depict examples of the pre-processing cell 110. FIG. 7 depicts an example of the wire automation cell 120. FIGS. 8-10 depict examples of the post-processing cell 130.

As illustrated in FIGS. 1 and 3-10, in one or more examples, the system 100 includes the jig board 200, the pre-processing cell 110, the wire automation cell 120, and the post-processing cell 130. The jig board 200 is configured for assembly of an electrical wire raceway 300. The jig board 200 is configured for routing of wires 310 forming the electrical wire raceway 300 along a linear path 202 and a non-linear path 204. The pre-processing cell 110 is configured for placement of wire raceway hardware 340 and wire routing hardware 240 on the jig board 200. The wire automation cell 120 is configured for automated placement of the wires 310 on the jig board 200. The post-processing cell 130 is configured for removal of the electrical wire raceway 300 from the jig board 200.

The jig board 200 may also be referred to as a form board and is configured for connection of wire raceway hardware 340 and the routing of wires 310 along routing paths for the assembly of wire bundles 330 in varying configurations to form the electrical wire raceway 300. Generally, for the purpose of the present disclosure, the electrical wire raceway 300 refers to bundles of wire, cables, conduits, connectors, and related fittings used to connect various electrical and electromechanical components. The electrical wire raceway 300 may also be referred to as an electrical wire harness.

The wire raceway hardware 340 includes any associated component of the electrical wire raceway 300 that is removed from the jig board 200 and stays with the electrical wire raceway 300 when the electrical wire raceway 300 is removed from the jig board 200 or that otherwise forms a part of the electrical wire raceway 300, also referred to as flyaway components. Examples of the wire raceway hardware 340 include, but are not limited to, a current return network 342 (CRN) and components thereof, electrical connectors 344, such as clamps, fittings, and the like.

The wire routing hardware 240 includes any associated component of the electrical wire raceway 300 that temporarily holds the components of the electrical wire raceway 300, such as the wires 310 of wire bundle 330, or that otherwise stays with jig board 200 when the electrical wire raceway 300 is removed from the jig board 200, also referred to as non-flyaway components. Examples of the wire routing hardware 240 include, but are not limited to, wire guides 242 that support or guide the wires 310 along the predetermined wire routing path, wire holders 244 that temporarily hold or secure the wires 310 in groups (e.g., wire bundle 330) along the wire routing path, and other connectors, fittings, and the like.

As illustrated in FIGS. 1 and 3-10, in one or more examples, the system 100 includes the transportation platform 140. The transportation platform 140 is configured for moving the jig board 200 sequentially through the pre-processing cell 110, the wire automation cell 120, and the post-processing cell 130. In one or more examples, the transportation platform 140 is at least partially manually operated and controlled. In one or more examples, the transportation platform 140 is at least partially automatically operated and controlled, such as by the computer system 190.

The transportation platform 140 can include any device or mechanism configured for moving components, materials, or subassemblies between different manufacturing cells within the manufacturing environment. The transportation platform 140 enhances efficiency, reduces manual labor, and optimizes workflow. Throughout the present disclosure, examples of the transportation platform 140 are described and illustrated as including or being formed by conveyor devices or systems that transfer the jig board 200 between manufacturing cells. However, in other examples, the transportation platform 140 includes autonomous mobile robots, automated guided vehicles, conveyor systems, overhead rail systems, modular transport carts or trolleys, and the like,

As illustrated in FIGS. 1 and 3-9, in one or more examples, the system 100 includes the computer system 190. The computer system 190 is configured (e.g., adapted or programmed) to control automated operations of the system 100. In one or more examples, the computer system 190 is configured to control automated movement of the jig board 200 through the pre-processing cell 110, the wire automation cell 120, and the post-processing cell 130 using the transportation platform 140. In one or more examples, the computer system 190 is further configured to control automated routing of wires 310 forming the wire bundles 330 of the electrical wire raceway 300, for example, using robotic manipulators 180 (FIGS. 1 and 7). In one or more examples, the computer system 190 receives input signals from sensors 184 and/or other input devices 186 (FIG. 1) that indicate a position or location of the jig board 200 and/or assembly condition or status of the electrical wire raceway 300 for instruction of movement and processing operations.

As illustrated in FIGS. 1 and 3-5, in one or more examples, the pre-processing cell 110 includes various manufacturing, fabrication, and assembly tools, fixtures, and equipment needed for preparing the jig board 200 for assembly and production of the electrical wire raceway 300, such as installation of the wire raceway hardware 340 and the wire routing hardware 240 at predetermined locations on the routing surface 206 of the jig board 200. The wire raceway hardware 340 and/or the wire routing hardware 240 can be installed on the jig board 200 manually, automatically, or by a combination of manual and automatic methods.

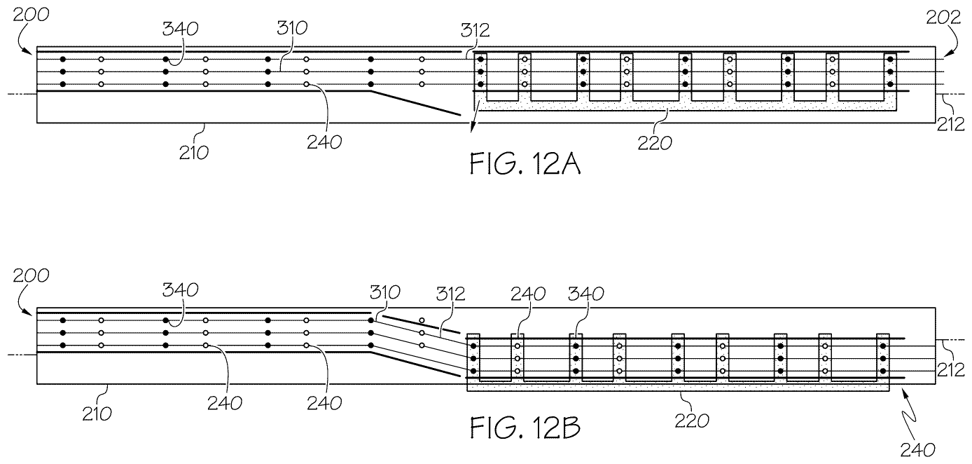

As illustrated in FIGS. 12-14, in one or more examples, the wire routing hardware 240 and/or the wire raceway hardware 340 are installed on the jig board 200 to support and/or connect the wires 310 of the wire bundles 330 according to predetermined wire routing paths. In one or more examples, the wire routing hardware 240 and the wire raceway hardware 340 are situated along linear paths 202 (e.g., generally linear wire routing paths) for routing of the wires 310.

As illustrated in FIGS. 1 and 3-5, in one or more examples, the pre-processing cell 110 includes the pre-processing workbench 112. The pre-processing workbench 112 is configured to support the jig board 200 during placement of the wire raceway hardware 340 and wire routing hardware 240. The pre-processing workbench 112 can include any suitable bench, table, or platform designed for supporting the jig board 200 during installation of the wire routing hardware 240 and the wire raceway hardware 340. In one or more examples, the pre-processing workbench 112 includes a frame and a work surface.

As illustrated in FIGS. 3 and 4, in one or more examples, the pre-processing cell 110 includes a plurality of pre-processing workbenches 112. In these examples, each one of the pre-processing workbenches 112 is positioned to feed into the wire automation cell 120. In one or more examples, the pre-processing workbench 112 is mobile or is otherwise movable within the pre-processing cell 110 and/or relative to the wire automation cell 120 for positioning and passing the jig board 200 into the wire automation cell 120.

As illustrated in FIGS. 1 and 3, in one or more examples, the pre-processing cell 110 includes the staging bench 116. The staging bench 116 is configured to support and stage one or more of the board sections 230 of the jig board 200 for transfer to and assembly at the pre-processing workbench 112. In one or more examples, the staging bench 116 includes a frame and a work surface.

As illustrated in FIGS. 1, 5 and 6, in one or more examples, the pre-processing cell 110 includes the pre-processing board lock 114. The pre-processing board lock 114 is configured to securely hold the jig board 200 relative to the pre-processing workbench 112 during placement of the wire raceway hardware 340 and wire routing hardware 240. In one or more examples, the pre-processing board lock 114 is coupled to or otherwise integrated with the pre-processing workbench 112. As an example, an instance of the pre-processing board lock 114 can be positioned at each end of the pre-processing workbench 112 or at a number of other locations along the pre-processing workbench 112 for selective engagement with the jig board 200. Actuation of the pre-processing board lock 114 can be performed manually or automatically, such as by instruction from the computer system 190. The pre-processing board lock 114 enhances process stability and ensures alignment accuracy, as well as reduces cycle times (e.g., by automating securing and release functions).

As illustrated in FIGS. 1, 3, 6 and 7, in one or more examples, the wire automation cell 120 includes various manufacturing, fabrication, and assembly tools, fixtures, and equipment needed for placing and routing the wires 310 of the electrical wire raceway 300 into wire bundles 330 according to the wire routing path. The wires 310 can be placed and routed on the jig board 200 manually, automatically, or by a combination of manual and automatic methods.

In one or more examples, the wires 310 are placed (e.g., individually or as groups) at predetermined locations on the routing surface 206 of the jig board 200 and are connected to the wire raceway hardware 340 and the wire routing hardware 240 by the robotic manipulators 180. In these examples, the robotic manipulators 180 are precision-engineered robotic systems designed to handle, route, and secure wires in automated manufacturing processes. The robotic manipulators 180 enhance efficiency, accuracy, and repeatability in assembly of the electrical wire raceway 300. One or more of the robotic manipulators 180 includes a multi-axis robotic arm, an end-effector (e.g., end effectors 182) configured for gripping and placing wire, and programmable motion control (e.g., programmable logic circuit). In one or more examples, the wire automation cell 120 also includes sensors (e.g., sensors 184), such as camera-based machine vision sensors, force sensors, proximity sensors, etc.) that ensure proper placement of the wires 310.

As illustrated in FIGS. 1, 3, 6 and 7, in one or more examples, the wire automation cell 120 includes the wire automation workbench 122. The wire automation workbench 122 is configured to support the jig board 200 during automated placement of the wires 310 into the wire raceway hardware 340 and the wire routing hardware 240, which were placed on the jig board 200 in the pre-processing cell 110. The wire automation workbench 122 can include any suitable bench, table, or platform designed for supporting the jig board 200 during placement of the wires 310 and formation of the wire bundles 330 of the electrical wire raceway 300. In one or more examples, the wire automation workbench 122 includes a frame and a work surface.

As illustrated in FIG. 7, in one or more examples, the wire automation cell 120 includes a plurality of wire automation workbenches 122. In one or more examples, each one of the wire automation workbenches 122 is positioned to receive the jig board 200 from an associated one of the pre-processing workbenches 112 of the pre-processing cell 110. In one or more examples, each one of the wire automation workbenches 122 is positioned to feed the jig board 200 to an associated one of the post-processing workbenches 132 of the post-processing cell 130. In one or more examples, the wire automation workbench 122 is mobile or is otherwise movable within the wire automation cell 120 for receiving the jig board 200 from the pre-processing cell 110, positioning the jig board 200 relative to the robotic manipulators 180, and/or passing the jig board 200 into the post-processing cell 130.

As illustrated in FIGS. 1 and 7, in one or more examples, the wire automation cell 120 includes wire automation board lock 124. The wire automation board lock 124 is configured to hold the jig board 200 relative to the wire automation workbench 122 during automated placement of the wires 310. In one or more examples, the wire automation board lock 124 is coupled to or otherwise integrated with the wire automation workbench 122. As an example, an instance of the wire automation board lock 124 can be positioned at each end of the wire automation workbench 122 or at a number of locations along the wire automation workbench 122 for selective engagement with the jig board 200. Actuation of the wire automation board lock 124 can be performed manually or automatically, such as by instruction from the computer system 190. The wire automation board lock 124 enhances process stability and ensures alignment accuracy, as well as reducing cycle times (e.g., by automating securing and release functions).

As illustrated in FIGS. 1, 3, 8-10, in one or more examples, the post-processing cell 130 includes various manufacturing, fabrication, and assembly tools, fixtures, and equipment needed for post-processing the jig board 200 and/or the electrical wire raceway 300 after assembly of the electrical wire raceway 300, such as inspection of the electrical wire raceway 300 and removal of the electrical wire raceway 300. The electrical wire raceway 300 can be inspected and/or removed from the jig board 200 manually, automatically, or by a combination of manual and automatic methods.

As illustrated in FIGS. 1, 3, 8 and 9, in one or more examples, the post-processing cell 130 includes the post-processing workbench 132. The 132 is configured to support the jig board 200 during removal of the electrical wire raceway 300 from the wire routing hardware 240 and the jig board 200. The post-processing workbench 132 can include any suitable bench, table, or platform designed for supporting the jig board 200 during inspection and/or removal of the electrical wire raceway 300. In one or more examples, the post-processing workbench 132 includes a frame and a work surface.

As illustrated in FIGS. 3 and 8, in one or more examples, the post-processing cell 130 includes a plurality of post-processing workbenches 132. In these examples, each one of the post-processing workbenches 132 is positioned to receive the jig board 200 from the wire automation cell 120. In one or more examples, the post-processing workbench 132 is mobile or is otherwise movable within the post-processing cell 130 and/or relative to the wire automation cell 120 for receiving the jig board 200 from the wire automation cell 120 and/or repositioning the jig board 200 for inspection or removal of the electrical wire raceway 300.

As illustrated in FIGS. 1 and 3, in one or more examples, the pre-processing cell 110 includes the transport bench 136. The transport bench 136 is configured to temporarily support and/or stage the jig board 200 for removal of the electrical wire raceway 300 from the jig board 200 in the post-processing cell 130. In one or more examples, the transport bench 136 includes a frame and a work surface. In one or more examples, the jig board 200 is moved from the post-processing workbench 132 to the transport bench 136 for removal of the electrical wire raceway 300.

As illustrated in FIGS. 1, 8 and 9, in one or more examples, the post-processing cell 130 includes the post-processing board lock 134. The post-processing board lock 134 is configured to hold the jig board 200 relative to the post-processing workbench 132 during inspection and/or removal of the electrical wire raceway 300 from the wire routing hardware 240 and the jig board 200. In one or more examples, the post-processing board lock 134 is coupled to or otherwise integrated with the post-processing workbench 132. As an example, an instance of the post-processing board lock 134 can be positioned at each end of the post-processing workbench 132 or at a number of locations along the post-processing workbench 132 for selective engagement with the jig board 200. Actuation of the post-processing board lock 134 can be performed manually or automatically, such as by instruction from the computer system 190. The post-processing board lock 134 enhances process stability and ensures alignment accuracy, as well as reduces cycle times (e.g., by automating securing and release functions).

Each one of the pre-processing board lock 114, the wire automation board lock 124, and the post-processing board lock 134 includes various mechanisms and components for releasable engagement with the jig board 200. In one or more examples, one or more of the pre-processing board lock 114, the wire automation board lock 124, and the post-processing board lock 134 includes an actuator and a locking element. The locking element is configured to engage and disengage a body of the jig board 200 for securing holding the jig board 200 in a desired position. The actuator is configured to drive the pre-processing board lock 114 between a disengaged and unlocked position and an engaged and locked position. In one or more examples, the actuator is pneumatic, electric, or electromechanical. In one or more example, the locking element is a clamp, a pin, or a latch. In one or more examples, one or more of the pre-processing board lock 114, the wire automation board lock 124, and the post-processing board lock 134 also includes sensors and a feedback system (e.g., proximity sensors, force sensors, etc.) and a control interface (e.g., programmable logic circuit and the like) that synchronizes actuation according to instructions from the computer system 190.

As illustrated in FIGS. 1 and 3-9, in one or more examples, the system 100 includes the first cell barrier 150 and the second cell barrier 160. The first cell barrier 150 is situated between the pre-processing cell 110 and the wire automation cell 120. The second cell barrier 160 is situated between the wire automation cell 120 and the post-processing cell 130. In one or more examples, the first cell barrier 150 and the second cell barrier 160 form portions or wall structures of the wire automation cell 120, thereby [physically segregating the wire automation cell 120 for safety.

As illustrated in FIGS. 1 and 3-9, in one or more examples, the transportation platform includes the pre-processing conveyor 142, the wire automation conveyor 144, and the post-processing conveyor 146. The pre-processing conveyor 142 is configured to feed the jig board 200 from the pre-processing cell 110 to the wire automation cell 120 through the first cell barrier 150. The wire automation conveyor 144 is configured to receive the jig board 200 from the pre-processing cell 110 through the first cell barrier 150, feed the jig board 200 into the wire automation cell 120, and feed the jig board 200 from the wire automation cell 120 to the post-processing cell 130 through the second cell barrier 160. The post-processing conveyor 146 is configured to receive the jig board 200 from the wire automation cell 120 through the second cell barrier 160 and feed the jig board 200 into the post-processing cell 130.

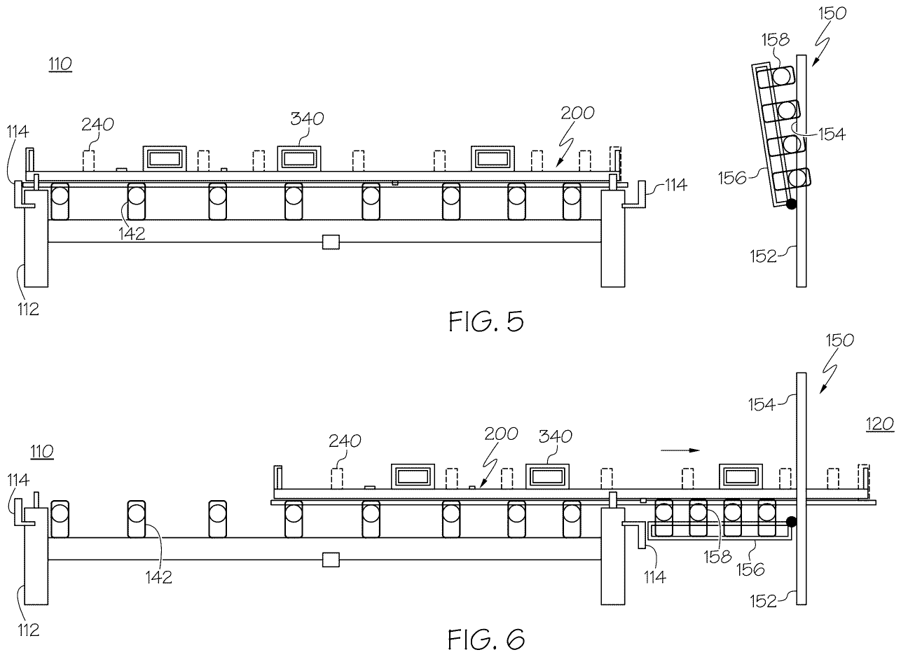

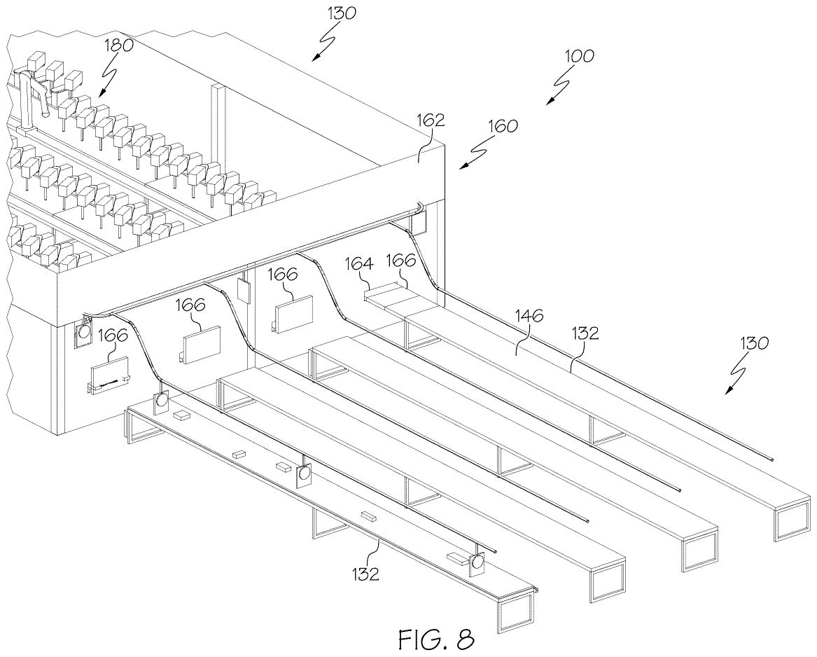

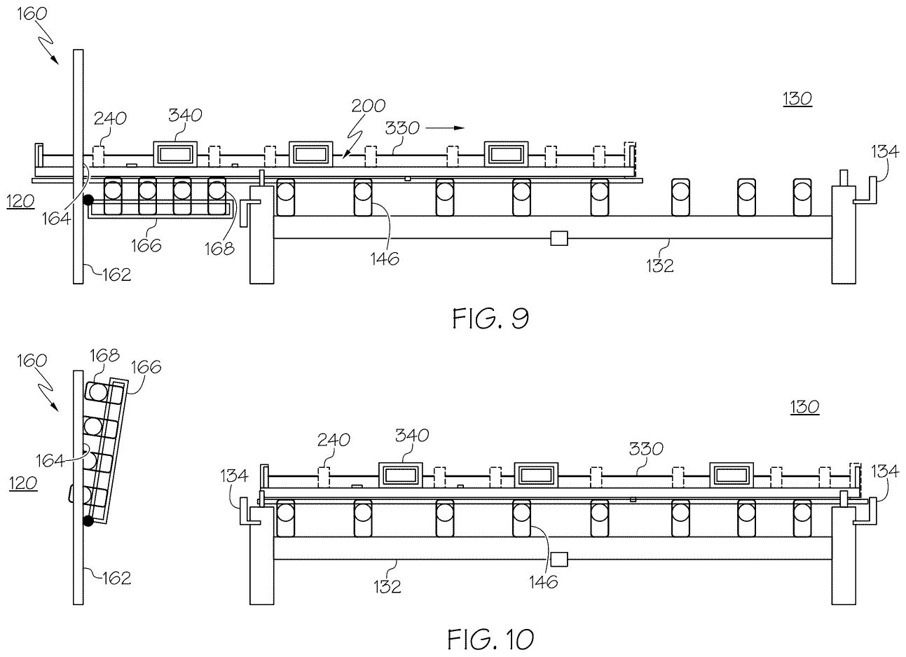

As illustrated in FIGS. 5 and 6, in one or more examples, the pre-processing conveyor 142 is coupled to or integrated with the pre-processing workbench 112. In one or more examples, the wire automation conveyor 144 is coupled to or integrated with the wire automation workbench 122. As illustrated in FIGS. 9 and 10, in one or more examples, the post-processing conveyor 146 is coupled to or integrated with the post-processing workbench 132.

In one or more examples, the pre-processing conveyor 142, the wire automation conveyor 144, and the post-processing conveyor 146 include any necessary components of and/or, in combination, form a conveyor system for transporting the jig board 200 between the different manufacturing cells of the system 100. The pre-processing conveyor 142, the wire automation conveyor 144, and the post-processing conveyor 146 enhance workflow efficiency, reduce manual handling, and integrate seamlessly with the manual and automated processes. In one or more examples, the pre-processing conveyor 142, the wire automation conveyor 144, and/or the post-processing conveyor 146 includes one or more of belt conveyors, roller conveyors, chai conveyors, slat conveyors, overhead conveyors, and the like and includes a drive system (e.g., motors), sensors (e.g., sensors 184) such as proximity sensors, weight sensors, barcode or RFID readers, and a controller (e.g., programmable logic circuit) to synchronize operation as instructed by the computer system 190.

As illustrated in FIGS. 1 and 3-7, in one or more examples, the first cell barrier 150 includes the first partition 152, the first passage 154, and the first gate 156. The first partition 152 forms a portion of a wall around the wire automation cell 120 that serves as a physical barrier between the pre-processing cell 110 and the wire automation cell 120. The first partition 152 includes or forms the first passage 154. The first passage 154 enables the jig board 200 to pass from the pre-processing workbench 112 of the pre-processing cell 110 to the wire automation workbench 122 of the wire automation cell 120. The first gate 156 is coupled to the first partition 152 and covers the first passage 154. The first gate 156 is movable between a first closed position and a first open position for opening or closing the first passage 154.

As illustrated in FIGS. 1, 3 and 6-9, in one or more examples, the second cell barrier 160 includes the second partition 162, the second passage 164, and the second gate 166. The second partition 162 forms a portion of a wall around the wire automation cell 120 that serves as physical barrier between the wire automation cell 120 and the post-processing cell 130. The second partition 162 includes or forms the second passage 164. The second passage 164 enables the jig board 200 to pass from the wire automation workbench 122 of the wire automation cell 120 to the post-processing workbench 132 of the post-processing cell 130. The second gate 166 is coupled to the second partition 162 and covers the second passage 164. The second gate 166 is movable between a second closed position and a second open position for opening or closing the second passage 164.

The first cell barrier 150 and the second cell barrier 160 and the components thereof protect workers, equipment, and the production environment by preventing unintended human contact with moving robotic systems of the wire automation cell 120, such as the robotic manipulators 180. The barriers also ensure compliance with safety regulations and reduce the risk of injuries or malfunctions in automated production facilities. In one or more examples, the first partition 152 and the second partition 162 include one or more of physical safety barriers, light curtains, laser scanners, pressure-sensitive mats, and the like. In one or more examples, the first cell barrier 150 and the second cell barrier 160 include sensors (e.g., sensors 184) or other safety features, such as motion sensors, pressure sensors, and the like that detect approaching objects. In one or more examples, the first cell barrier 150 and/or the second cell barrier 160 ensure worker safety, regulatory compliance, uninterrupted production, prevent accidents, and improve overall workplace efficiency.

In one or more examples, the first gate 156 and/or the second gate 166 include any suitable mechanical device that regulates passage through the first passage 154 and the second partition 162, respectively. In one or more examples, the first gate 156 and/or the second gate 166 can be operated manually or automatically, such as under instruction from the computer system 190. In one or more examples, the first gate 156 and/or the second gate 166 include various operational components, including a structural frame, an opening and closing mechanism (e.g., a sliding mechanism, a swinging mechanism, a rolling mechanism, a shutter mechanism, a telescopic mechanism, etc.), an actuator, and a controller. In one or more examples, the first gate 156 and/or the second gate 166 include sensors (e.g., sensors 184) or other safety features, such as motion sensors or pressure sensors that detect approach or exit of the jig board 200 and prevent closing if an obstruction is detected within the first passage 154 or the second passage 164, respectively.

As illustrated in FIGS. 1, 3 and 6-9, in one or more examples, the transportation platform 140 also includes the first barrier conveyor 158 and the second barrier conveyor 168. The first barrier conveyor 158 is configured to feed the jig board 200 from the pre-processing workbench 112 to the wire automation workbench 122, for example, through the first passage 154. The second barrier conveyor 168 is configured to feed the jig board 200 from the wire automation workbench 122 to the post-processing workbench 132, for examples, through the second passage 164.

As illustrated in FIGS. 5 and 6, in one or more examples, the first barrier conveyor 158 is coupled to or integrated with the first gate 156. In one or more examples, the first gate 156 is a pivot or swing door (e.g., pivot-down swing door) and the first barrier conveyor 158 is positioned between the pre-processing conveyor 142 and the wire automation conveyor 144 when the first passage 154 is open. As illustrated in FIGS. 9 and 10, in one or more examples, the second barrier conveyor 168 is coupled to or integrated with the second gate 166. In one or more examples, the second gate 166 is a pivot or swing door (e.g., pivot-down swing door) and the second barrier conveyor 168 is positioned between the wire automation conveyor 144 and the post-processing conveyor 146 when the second passage 164 is open.

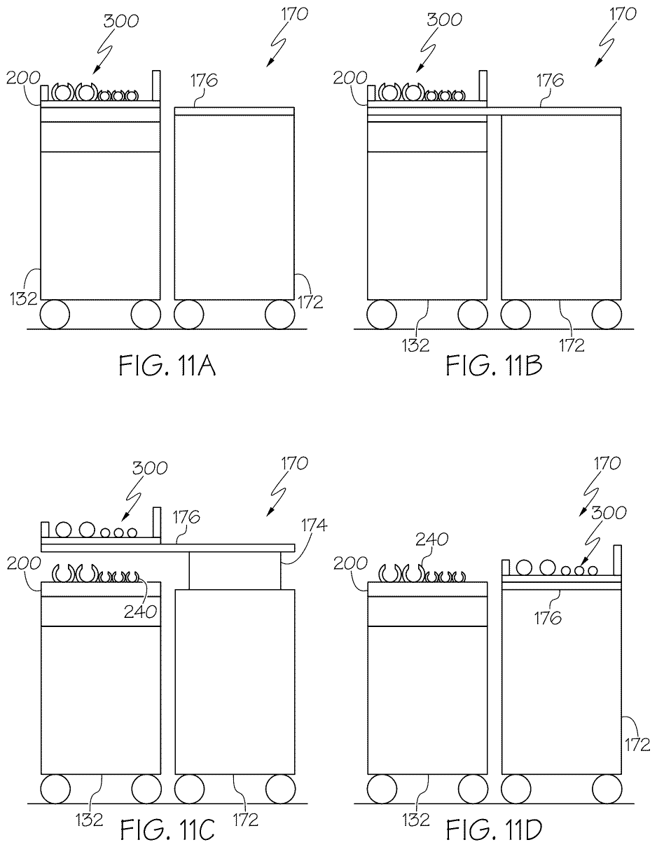

As illustrated in FIGS. 1 and 11, in one or more examples, the system 100 includes the transport tool 170. The transport tool 170 is configured to remove the electrical wire raceway 300 (e.g., the wire bundle 330 and the wire raceway hardware 340) from of the jig board 200. In one or more examples, the transport tool 170 is configured to remove the electrical wire raceway 300 from the jig board 200 while the jig board 200 is on the post-processing workbench 132 in the post-processing cell 130. In one or more examples, the jig board 200 is moved from the post-processing workbench 132 to the transport bench 136, and the transport tool 170 is configured to remove the electrical wire raceway 300 from the jig board 200 while the jig board 200 is on the transport bench 136 in the post-processing cell 130.

As illustrated in FIGS. 1 and 11, in one or more examples, the transport tool 170 includes the mobile platform 172. The vertical mast 174 is coupled to the mobile platform 172. At least one, such as a plurality of the horizontal tines 176 is coupled to and is movable relative to the vertical mast 174 to lift the electrical wire raceway 300 from the wire routing hardware 240 and off of the jig board 200.

As illustrated in FIG. 11A, in one or more examples, the mobile platform 172 is any suitable self-propelled or manually propelled vehicle. During removal of the electrical wire raceway 300 from the jig board 200, the mobile platform 172 is aligned with or positioned adjacent to and proximate (e.g., at or near) the post-processing workbench 132 (or the transport bench 136). As illustrated in FIG. 11B, the horizontal tines 176 are configured to fit between the electrical wire raceway 300 and the jig board 200. As illustrated in FIG. 11C, in one or more examples, the vertical mast 174 is configured to raise the electrical wire raceway 300, supported on the horizontal tines 176, away from the jig board 200, thereby disengaging and removing the electrical wire raceway 300 from the wire routing hardware 240. As illustrated in FIG. 11D, the vertical mast 174 is configured to lower the electrical wire raceway 300 onto the mobile platform 172. The transport tool 170 can then be used to transport the completed electrical wire raceway 300 for final installation.

Referring now to FIGS. 1 and 12-14, by way of examples, the present disclosure is directed to the jig board 200 for routing wire raceways, wire harnesses, wire bundles, and the like. The following are examples of the jig board 200, according to the present disclosure. Examples of the jig board 200 include a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

FIG. 1 also depicts one or more examples of the jig board 200. In various examples, the jig board 200 includes a number of elements, features, and/or components, including one or more, or combinations, of the board assembly 250, the primary board 210, the secondary board 220, and the wire routing hardware 240.

Generally, the jig board 200 is used to support the wire routing hardware 240 (e.g., non-flyaway hardware such as routing supports, spanner bars, wire holders, disconnect brackets, etc.) and the wire raceway hardware 340 (e.g., flyaway hardware such as electrical connectors, electrical fittings, bundling straps, printed wiring boards, current return networks, spanners, etc.) through the assembly process. The jig board 200 can have any feasible dimensions (e.g., length) to accommodate the dimensions of the electrical wire raceway 300. As an example, the jig board 200 is assembled using a plurality of board sections 230, each being approximately eight feet long. Use of the board sections 230 accommodates storage and transport. In these examples, the board sections 230 are connected or coupled together in an end-to-end manner to form the assembled jig board 200 used to support assembly of the electrical wire raceway 300.

The present disclosure recognizes that certain electrical raceways, or specific lanes or wire bundles within an electrical raceway, may require lateral jogs or other non-linear sections to avoid interference with other components when installed in its final application. However, automated wire placement operations performed by the robotic manipulators 180 are limited to routing wires along a straight or linear route path, resulting in an electrical raceway in which each lane or bundle of wires is in a straight or linear configuration. Examples of the jig board 200 disclosed herein overcome this limitation and facilitate lateral jogs or other non-linear sections of the electrical wire raceway 300.

As will be described herein, in various examples, the jig board 200 includes multiple boards (e.g., primary board 210 and secondary board 220) that are movable relative to each other. The wire routing hardware 240 is mounted on both boards such that the wires 310 are placed and routed in a straight configuration. After placement of the wires 310, one or more portions of one or more boards is laterally moved relative to another one or more portions of another one or more boards such that one or more sections of the electrical wire raceway 300 is repositioned from a straight configuration to a jogged configuration.

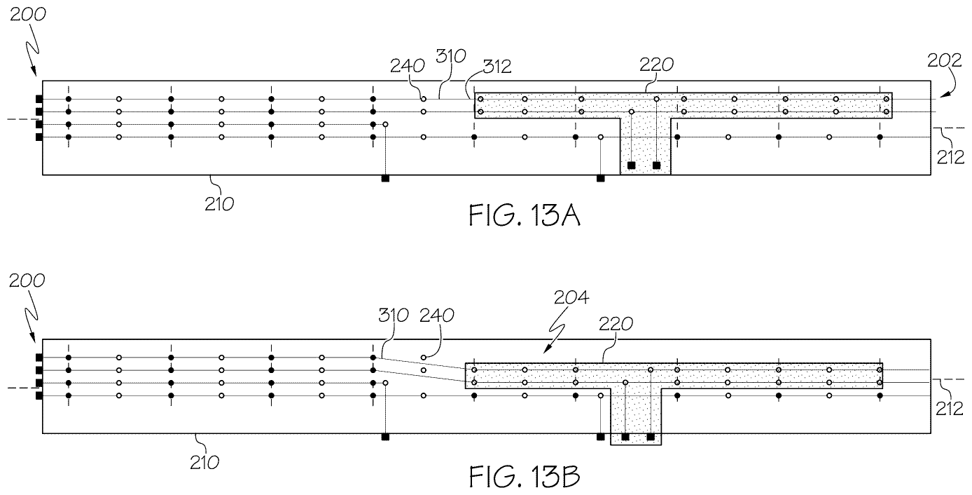

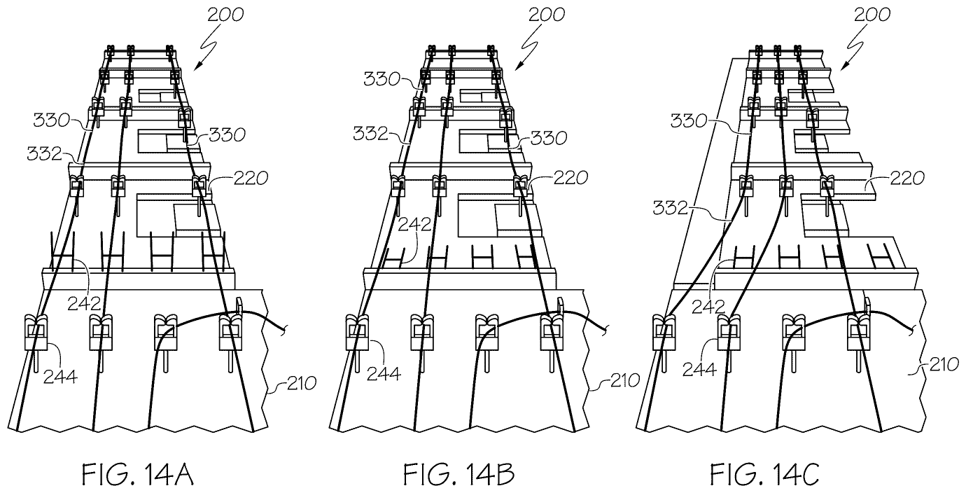

FIGS. 12A, 13A, 14A and 14B depict examples of the jig board 200 with the boards (e.g., primary board 210 and secondary board 220) in the straight or assembly configuration for placing the wires 310 along a straight or linear route path. FIGS. 12B, 13B, and 14C depict examples of the jig board 200 with the boards (e.g., primary board 210 and secondary board 220) moved to a jogged configuration for repositioning at least one section of the electrical wire raceway 300 along a non-linear path. FIG. 12 illustrates an example of the jig board 200 in which a section of an entirety of the electrical wire raceway 300 is repositioned from the straight configuration (FIG. 12A) to the jogged configuration (FIG. 12B). FIGS. 13 and 14 illustrate examples in which only certain lanes of wire bundles 330 of the electrical wire raceway 300 are repositioned from the straight configuration (FIGS. 13A, 14A and 14B) to the jogged configuration (FIGS. 13B and 14C).

As illustrated in FIGS. 1 and 12-14, in one or more examples, the jig board 200 includes the primary board 210 and the secondary board 220. The secondary board 220 is coupled to the primary board 210. The secondary board 220 is movable relative to the primary board 210. Movement of the secondary board 220 relative to the primary board 210 facilitates the rerouting of at least one wire section 312 of the wires 310 (or at least one wire bundle section 332 of the wire bundle 330) from the linear path 202 (e.g., FIGS. 12A, 13A, 14A and 14B) to the non-linear path 204 (e.g., FIGS. 12B, 13B and 14C). The rerouting of the wires 310 or wire bundle 330 from the linear path 202 to the non-linear path 204 occurs after placing or initially routing all of the wires 310 or wire bundle 330 along the linear path 202.

As illustrated in FIGS. 12 and 13, in one or more examples, the secondary board 220 is laterally movable relative to the primary board 210 between the straight position and the jogged position. As an example, the primary board 210 has a longitudinal axis 212. The secondary board 220 is movable in a direction at least approximately perpendicular to the longitudinal axis 212.

As illustrated in FIG. 1, in one or more examples, the jig board 200 includes any one of various mechanical couplings that connect the primary board 210 and the secondary board 220 together and enable movement of the secondary board 220 relative to the primary board 210 for creating a non-linear section of the electrical wire raceway 300 using the jig board 200. As examples, the jig board 200 includes a movement assembly 260 coupled to the primary board 210 and the secondary board 220 or coupling the primary board 210 and the secondary board together and that enables relative movement of the primary board 210 and the secondary board 220. As examples, the movement assembly 260 includes one or more of a linear rail and guide assembly, a slot and pin assembly (e.g., sliding dovetail), a telescopic mechanism (e.g., nested sliding boards), a ball-and-groove track assembly, and the like. In one or more examples, actuation (e.g., lateral movement or translation) of the secondary board 220 relative to the primary board 210 is performed manually. In one or more examples, actuation (e.g., lateral movement or translation) of the secondary board 220 relative to the primary board 210 is performed automatically, such as by an actuator, which is integrated with or coupled to the movement mechanism, based on instruction from the computer system 190.

As illustrated in FIGS. 12-14, in one or more examples, the wire routing hardware 240 is coupled to the primary board 210 and to the secondary board 220. The wire routing hardware 240 includes wire guides 242 and wire holders 244. At least some of the wire guides 242, which are coupled to the primary board 210, are pivotal, flexible, retractable or otherwise movable between an up (e.g., upright) position (e.g., FIG. 13A) and a down (e.g., folded down) position (e.g., FIGS. 13B and 13C) to permit movement of the wire section 312 (or wire bundle section 332) from the linear path 202 (e.g., FIGS. 11A, 12A and 13A) to the non-linear path 204 (e.g., FIGS. 11B, 12B, 13C).

As illustrated in FIGS. 1 and 12-14, in one or more examples, the jig board 200 includes the board assembly 250. In one or more examples, the board assembly 250 includes the plurality of the board sections 230. The board assembly 250 is configured for routing the wires 310 into the wire bundle 330 along the linear path 202 and for re-routing at least some of the wires 310 (e.g., a section of the wire bundle 330) from the linear path 202 to the non-linear path 204. The jig board 200 also includes the wire routing hardware 240 that is coupled to the board assembly 250.

In one or more examples, the board assembly 250, such as at least one of the board sections 230, includes the primary board 210 and the secondary board 220. The primary board 210 includes the longitudinal axis 212. The secondary board 220 is coupled to the primary board 210. The secondary board 220 is movable relative to the primary board 210. In one or more examples, the secondary board 220 is movable relative to the primary board 210 in a direction that is at least approximately perpendicular to the longitudinal axis 212. Movement of the secondary board 220 relative to the primary board 210 facilities rerouting the wire section 312 of the wires 310 (or the wire bundle section 332 of the wire bundle 330) from the linear path 202 to the non-linear path 204. The wire routing hardware 240 is coupled to the primary board 210 and the secondary board 220. The wire routing hardware 240 includes the wire guides 242. At least some of the wire guides 242, which are coupled to the primary board 210, are pivotal between the upright position and the folded down position to permit movement of the wire section 312 (or the wire bundle section 332) from the linear path 202 to the non-linear path 204.

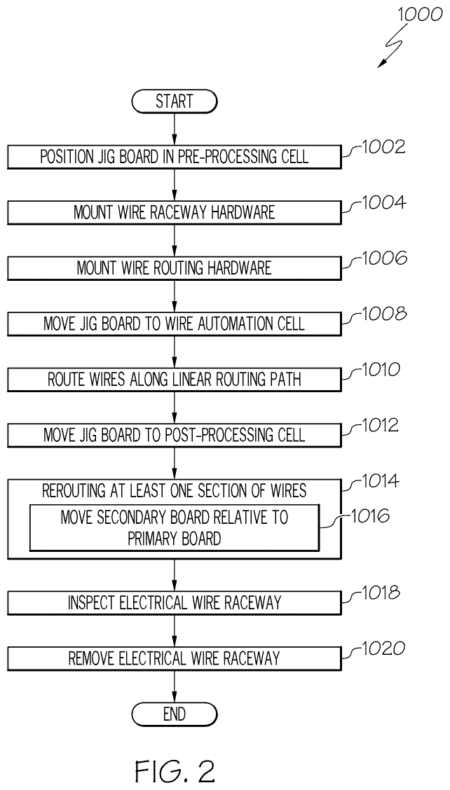

Referring now to FIG. 2, by way of examples, present disclosure is also directed to a method 1000 for automated assembly or production of wire raceways, wire harnesses, wire bundles, and the like, which is also referred to herein as a wire automation method. The following are examples of the method 1000, according to the present disclosure. In one or more examples, the method 1000 is implemented using the system 100 or the jig board 200. Examples of the method 1000 include a number of elements, steps, operations, or processes. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein.

In one or more examples, the method 1000 includes a step of positioning 1002 the jig board 200 in the pre-processing cell 110. In one or more examples, the jig board 200 is assembled from the board sections 230. In one or more examples, the board sections 230 are stored and staged for assembly into the jig board 200.

In one or more examples, the method 1000 includes a step of mounting 1004 of coupling the wire raceway hardware 340 and a step of mounting 1006 or coupling the wire routing hardware 240 to the jig board 200. The wire raceway hardware 340 and the wire routing hardware 240 are positioned on the jig board 200 such that the wires 310 of the electrical wire raceway 300 can be automatically placed (e.g., routed using programmable controlled robotic manipulators) along the linear path 202. The wire raceway hardware 340 and/or the wire routing hardware 240 can be located and mounted to the routing surface 206 of the jig board 200 manually or automatically.

In one or more examples, the method 1000 includes a step of moving 1008 the jig board 200 from the pre-processing cell 110 to the wire automation cell 120. In one or more examples, the jig board 200 is transferred from the pre-processing cell 110 to the wire automation cell 120 after mounting the wire raceway hardware 340 and the wire routing hardware 240 using the transportation platform 140. In one or more examples, moving the jig board 200 from the pre-processing cell 110 to the wire automation cell 120 can be performed manually or automatically.

In one or more examples, the method 1000 includes a step of routing 1010 the wires 310 along a linear routing path (e.g., the linear path 202) on the jig board 200 to form the wire bundle 330. In one or more examples, the wires 310 are routed automatically, for example, using a plurality of the robotic manipulators 180. The wires 310 of the wire bundle 330 are coupled to (e.g., supported by, mounted to, guided by, etc.) the wire raceway hardware 340 and the wire routing hardware 240 during or after routing of the wires 310.

In one or more examples, the method 1000 includes a step of moving 1012 the jig board 200 from the wire automation cell 120 to the post-processing cell 130. In one or more examples, the jig board 200 is transferred from the wire automation cell 120 to the post-processing cell 130 after placing the wires 310 and forming wire bundles 330 using the transportation platform 140. In one or more examples, moving the jig board 200 from the wire automation cell 120 to the post-processing cell 130 can be performed manually or automatically.

In one or more examples, the method 1000 includes a step of rerouting 1014 at least one section of the wires 310, such as a wire bundle section 332 of the wire bundle 330, from the linear path 202 to the non-linear path 204 using the jig board 200. Rerouting of the wires 310 from the linear path 202 to the non-linear path 204 creates a jog or other non-straight section or length in one or more lanes of wire bundles 330 of the electrical wire raceway 300. As illustrated in FIGS. 12-14, in one or more examples, according to the method 1000, the step of rerouting 1014 the wire bundle section 332 of the wire bundle 330 from the linear path 202 to the non-linear path 204 includes a step of moving 1016 the secondary board 220 of the jig board 200 relative to the primary board 210 of the jig board 200.

In one or more examples, the method 1000 includes a step of inspecting 1018 the electrical wire raceway 300. In one or more examples, inspection of the electrical wire raceway 300 is performed manually, automatically, or by a combination thereof. In one or more examples, inspection includes performing a continuity test on the wire bundle 330 in the post-processing cell 130. The continuity test can be a physical test in which wires are inspected for damage, proper connection, and number. The continuity test can also be an electrical continuity test.

In one or more examples, the method 1000 includes a step of removing 1020 the wire bundle 330 and the wire raceway hardware 340 from the jig board 200 in the post-processing cell 130. In one or more examples, the electrical wire raceway 300 is removed using the transport tool 170.

Referring to FIG. 1, in one or more examples, one or more automated components of the system 100 can be programmed to produce the electrical wire raceway 300 using the computer system 190. With robots and associated microprocessors and/or computers, the specifications for the electrical wire raceway 300 can be input into the computer system 190 manually or with CAD equipment and can be converted to control data to activate and control the robotic manipulators 180 and move the jig board 200 through the cells of the system 100. Automated control of system components can be achieved through a data generator control program running on a computer with downloaded control data passing to the internal systems controller (CPU or microprocessor) of each unit in the system. In one or more examples, controllers of the automated components of the system 100 include or receive commands from the computer system 190. The computer system 190 is a date processing system that includes processor 192 configured with executable computer code (e.g., program code 196) stored in a non-transitory tangible computer-readable storage medium (e.g., memory 194).

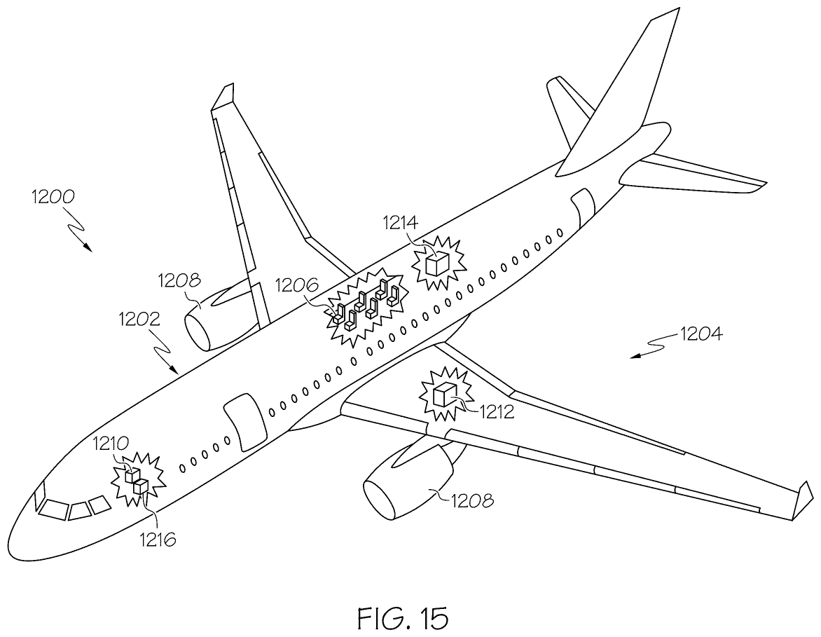

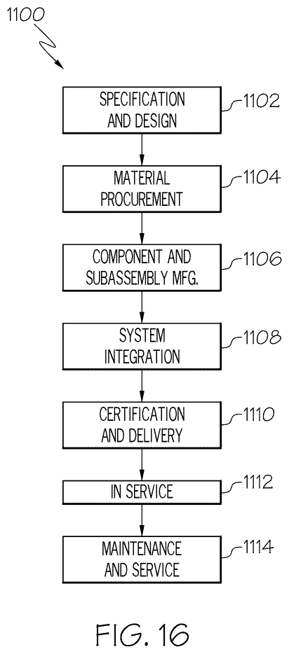

Referring now to FIGS. 15 and 16 examples of the system 100, the jig board 200, the method 1000, described herein, may be related to, or used in the context of, an aircraft 1200, as schematically illustrated in FIG. 15, and the aerospace manufacturing and service method 1100, as shown in the flow diagram of FIG. 16. As an example, the aircraft 1200 and/or the manufacturing and service method 1100 may utilize wire raceways that are assembled using the system 100 or the jig board 200 and/or according to the method 1000.

Referring to FIG. 15, which illustrates an example of the aircraft 1200. The aircraft 1200 can be any aerospace vehicle or platform. In one or more examples, the aircraft 1200 includes the airframe 1202 having the interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to the airframe 1202 of the aircraft 1200. In yet other examples, the onboard systems 1204 also include one or more other systems 1216, such as, but not limited to, communications systems, avionics systems, software distribution systems, network communications systems, passenger information/entertainment systems, guidance systems, radar systems, weapons systems, and the like. The aircraft 1200 can include wire raceways that are assembled using the system 100 or the jig board 200 and/or according to the method 1000.

Referring to FIG. 16, during pre-production of the aircraft 1200, the manufacturing and service method 1100 includes specification and design 1102 of the aircraft 1200 and material procurement 1104. During production of the aircraft 1200, component and subassembly manufacturing 1106 and system integration 1108 of the aircraft 1200 take place. Thereafter, the aircraft 1200 goes through certification and delivery 1110 to be placed in service 1112. Routine maintenance and service 1114 includes modification, reconfiguration, refurbishment, etc. of one or more systems of the aircraft 1200.

Each of the processes of the manufacturing and service method 1100 illustrated in FIG. 16 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of the system 100, the jig board 200, and method 1000, shown and described herein, may be employed during any one or more of the stages of the manufacturing and service method 1100 shown in the flow diagram illustrated by FIG. 16. In an example, wire raceways (e.g., electrical wire raceway 300) of the aircraft 1200 are assembled using the system 100 or the jig board 200 and/or according to the method 1000 during a portion of component and subassembly manufacturing 1106 and/or system integration 1108. Further, wire raceways (e.g., electrical wire raceway 300) of the aircraft 1200 are assembled using the system 100 or the jig board 200 and/or according to the method 1000 while the aircraft 1200 is in service 1112. Also, wire raceways (e.g., electrical wire raceway 300) of the aircraft 1200 are assembled using the system 100 or the jig board 200 and/or according to the method 1000 during system integration 1108 and certification and delivery 1110. Similarly, wire raceways (e.g., electrical wire raceway 300) of the aircraft 1200 are assembled using the system 100 or the jig board 200 and/or according to the method 1000 while the aircraft 1200 is in service 1112 and during maintenance and service 1114.

While examples of the system 100, jig board 200, and method 1000 are described as having particular application and benefit to the aerospace industry, the system 100, jig board 200, and method 1000 are also highly adaptable to a range of other industrial applications, including automotive, marine, electronics, construction, manufacturing, machinery, and the like.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1 and 3-15, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1 and 3-15, referred to above, need to be included in every example and not all elements, features, and/or components described herein are necessarily depicted in each illustrative example. Accordingly, some of the elements, features, and/or components described and illustrated in FIGS. 1 and 3-15 may be combined in various ways without the need to include other features described and illustrated in FIGS. 1 and 3-15, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1 and 3-15, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1 and 3-15, and such elements, features, and/or components may not be discussed in detail herein with reference to each of FIGS. 1 and 3-15. Similarly, all elements, features, and/or components may not be labeled in each of FIGS. 1 and 3-15, but reference numerals associated therewith may be utilized herein for consistency.

In FIGS. 2 and 16, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 2 and 16 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need to be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the system 100, the jig board 200, and the method 1000 have been shown and described, modifications may occur to those skilled in the art upon reading the specification. The present application includes such modifications and is limited only by the scope of the claims.

What is claimed is:

1. A wire automation system comprising:
a jig board for assembly of an electrical wire raceway, wherein the jig board is configured for routing of wires along a linear path and a non-linear path;
a pre-processing cell for placement of wire raceway hardware and wire routing hardware on the jig board;
a wire automation cell for automated placement of the wires on the jig board, wherein the wire automation cell is linked in series with the pre-processing cell;
a post-processing cell for removal of the electrical wire raceway from the jig board, wherein the post-processing cell is linked in series with the wire automation cell; and
a transportation platform that moves the jig board sequentially through the pre-processing cell, the wire automation cell, and the post-processing cell.

2. The wire automation system of claim 1, further comprising a computer system configured to control automated movement of the jig board through the pre-processing cell, the wire automation cell, and the post-processing cell.

3. The wire automation system of claim 1, wherein:
the pre-processing cell comprises:
a pre-processing workbench that supports the jig board during placement of the wire raceway hardware and wire routing hardware; and
a pre-processing board lock to hold the jig board relative to the pre-processing workbench;
the wire automation cell comprises:
a wire automation workbench that supports the jig board during automated placement of the wires in the wire raceway hardware and the wire routing hardware; and
a wire automation board lock to hold the jig board relative to the wire automation workbench; and
the post-processing cell comprises:
a post-processing workbench that supports the jig board during removal of the electrical wire raceway from the jig board; and
a post-processing board lock to hold the jig board relative to the post-processing workbench.

4. The wire automation system of claim 1, further comprising:
a first cell barrier situated between the pre-processing cell and the wire automation cell; and
a second cell barrier situated between the wire automation cell and the post-processing cell.

5. The wire automation system of claim 4, wherein the transportation platform comprises:
a pre-processing conveyor that feeds the jig board from the pre-processing cell to the wire automation cell through the first cell barrier; and
a wire automation conveyor that feeds the jig board from the wire automation cell to the post-processing cell through the second cell barrier.

6. The wire automation system of claim 5, wherein:
the first cell barrier comprises:
a first partition having a first passage; and
a first gate coupled to the first partition and movable between a first closed position and a first open position; and
the second cell barrier comprises:
a second partition having a second passage; and
a second gate coupled to the second partition and movable between a second closed position and a second open position.

7. The wire automation system of claim 6, wherein the transportation platform further comprises:
a first barrier conveyor that feeds the jig board through the first passage; and
a second barrier conveyor that feeds the jig board through the second passage.

8. The wire automation system of claim 1, further comprising a transport tool configured to remove the electrical wire raceway from of the jig board in the post-processing cell.

9. The wire automation system of claim 8, wherein the transport tool comprises:
a mobile platform;
a vertical mast coupled to the mobile platform; and
a plurality of horizontal tines coupled to and movable relative to the vertical mast to lift the electrical wire raceway off of the jig board.

10. The wire automation system of claim 1, wherein the jig board comprises:
a primary board; and
a secondary board coupled to the primary board and movable relative to the primary board for rerouting a wire section of the wires from the linear path to the non-linear path.

11. The wire automation system of claim 10, wherein:
the primary board has a longitudinal axis; and
the secondary board is movable in a direction at least approximately perpendicular to the longitudinal axis.

12. The wire automation system of claim 10, the wire routing hardware is coupled to the primary board and the secondary board.

13. The wire automation system of claim 12, wherein:
the wire routing hardware comprises wire guides; and
at least some of the wire guides coupled to the primary board are pivotal between an upright position and a folded down position to permit movement of the wire section from the linear path to the non-linear path.

14. The wire automation system of claim 1, wherein the jig board comprises a plurality of board sections that are coupled together.

15. A jig board for assembly of an electrical wire raceway, the jig board comprising:
a board assembly configured for routing of wires along a linear path and a non-linear path; and
wire routing hardware coupled to the board assembly.

16. The jig board of claim 15, wherein:
the board assembly comprises:
a primary board having a longitudinal axis; and
a secondary board coupled to the primary board and movable relative to the primary board in a direction at least approximately perpendicular to the longitudinal axis for rerouting a wire section of the wires from the linear path to the non-linear path; and
the wire routing hardware is coupled to the primary board and the secondary board.

17. The jig board of claim 16, wherein:
the wire routing hardware comprises wire guides; and
at least some of the wire guides coupled to the primary board are pivotal between an upright position and a folded down position to permit movement of the wire section from the linear path to the non-linear path.

18. A method for assembling an electrical wire raceway, the method comprising:
positioning a jig board in a pre-processing cell;
coupling wire raceway hardware and wire routing hardware to the jig board along a linear path;
moving the jig board from the pre-processing cell to a wire automation cell;
automatically routing wires along the linear path on the jig board to form a wire bundle coupled to the wire raceway hardware and the wire routing hardware using a plurality of robotic manipulators;
moving the jig board from the wire automation cell to a post-processing cell; and
rerouting a wire bundle section of the wire bundle from the linear path to a non-linear path using the jig board.

19. The method of claim 18, wherein rerouting the wire bundle section of the wire bundle from the linear path to the non-linear path comprises:
moving a secondary board of the jig board relative to a primary board of the jig board.

20. The method of claim 18, further comprising:
performing a continuity test on the wire bundle in the post-processing cell; and
removing the wire bundle and the wire raceway hardware from the jig board in the post-processing cell.
